(19) United States
(12) Patent Application Publication
(10) Pub. No.: US 2012/0271702 A1
(43) Pub. Date: Oct. 25, 2012

(54) ELECTRONIC COMMERCE MANAGEMENT SYSTEM AND METHOD

(76) Inventors: Patrick MacLachlan, Vancouver (CA); Simon Droscher, Vancouver (CA); Todd Meade, Surrey (CA)

(21) Appl. No.: 13/093,829

(22) Filed: Apr. 25, 2011

(51) Int. Cl. G06Q 30/00

(52) U.S. Cl. 705/14.26

(57) ABSTRACT

A method for managing a promotional campaign in an electronic commerce system is provided. The method comprises, at an electronic commerce server receiving a virtual coupon use request including a multiple-user virtual coupon code from the user of the client program executed on a client device, detecting a distinguishing identifier associated with the virtual coupon use request from the user of the client program, determining eligibility criteria and at least one virtual coupon benefit corresponding to the virtual coupon code. The method further comprises at the electronic commerce server determining if the user of the client program from which the virtual coupon code was received is eligible to receive the virtual coupon benefit based on the distinguishing identifier and the eligibility criteria and if the user of the client program is eligible, providing the virtual coupon benefit to the user of the client program.

### BACKGROUND

Coupons are the means by which promotions are offered by merchants to customers in order to increase customer visits to and ultimately purchases of products and services from the merchant. While coupons have traditionally been paper items distributed via newspaper or direct mail, in the world of electronic commerce merchants have offered virtual coupons that are distributed electronically and are redeemable at online marketplaces. One type of virtual coupon has a generic code, such as “FREESHIP20” that is the same for all receivers of the coupon. One drawback with such an approach is that the merchant cannot enforce restrictions on the use of the generic code, and thus the coupon may be used too many times by a single user to be effective for the merchant, for example.

To address this, another approach has been introduced which utilizes a unique code for each instance of the virtual coupon that is issued. While this approach has the benefit of allowing per-coupon use restrictions to be implemented by the merchant, in practice it also has the drawback of being complicated and difficult to manage. Promotional campaigns that utilize unique codes for each coupon require more complicated and expensive software systems, and also require more labor by employees of the merchant in order to create and manage the promotional campaigns.

### SUMMARY

A method for managing a promotional campaign in an electronic commerce system is provided. The method may comprise, at an electronic commerce server, receiving a virtual coupon use request including a multiple-user virtual coupon code from the user of the client program executed on a client device, detecting a distinguishing identifier associated with the virtual coupon use request from the user of the client program, determining eligibility criteria and at least one virtual coupon benefit corresponding to the virtual coupon code. The method further may comprise, at the electronic commerce server, determining if the user of the client program from which the virtual coupon code was received is eligible to receive the virtual coupon benefit based on the distinguishing identifier and the eligibility criteria and if the user of the client program is eligible, providing the virtual coupon benefit to the user of the client program.

In this way, a non-unique multiple-user virtual coupon code may be used, which has the advantages of lower complexity and cost for campaign management, along with a distinguishing identifier for each user of the virtual coupon code, which has the advantage of being usable to effect use merchant restrictions on coupon use. Such a system has the potential benefit of enabling merchants to implement promotional campaigns with merchant-specified use restrictions placed on coupons, in a cost effective manner. These restrictions may include per-user and aggregate limits on coupon usage, for example, as discussed below.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an electronic commerce system according to one embodiment of the present invention.

FIGS. 2-3 show a method for managing a promotional campaign in an electronic commerce system, according to one embodiment of the present invention.

FIGS. 4-14 depict various windows generated via a promotional campaign generation user interface (UI) for defining various aspects of a promotional campaign in the electronic commerce system of FIG. 1.

### DETAILED DESCRIPTION

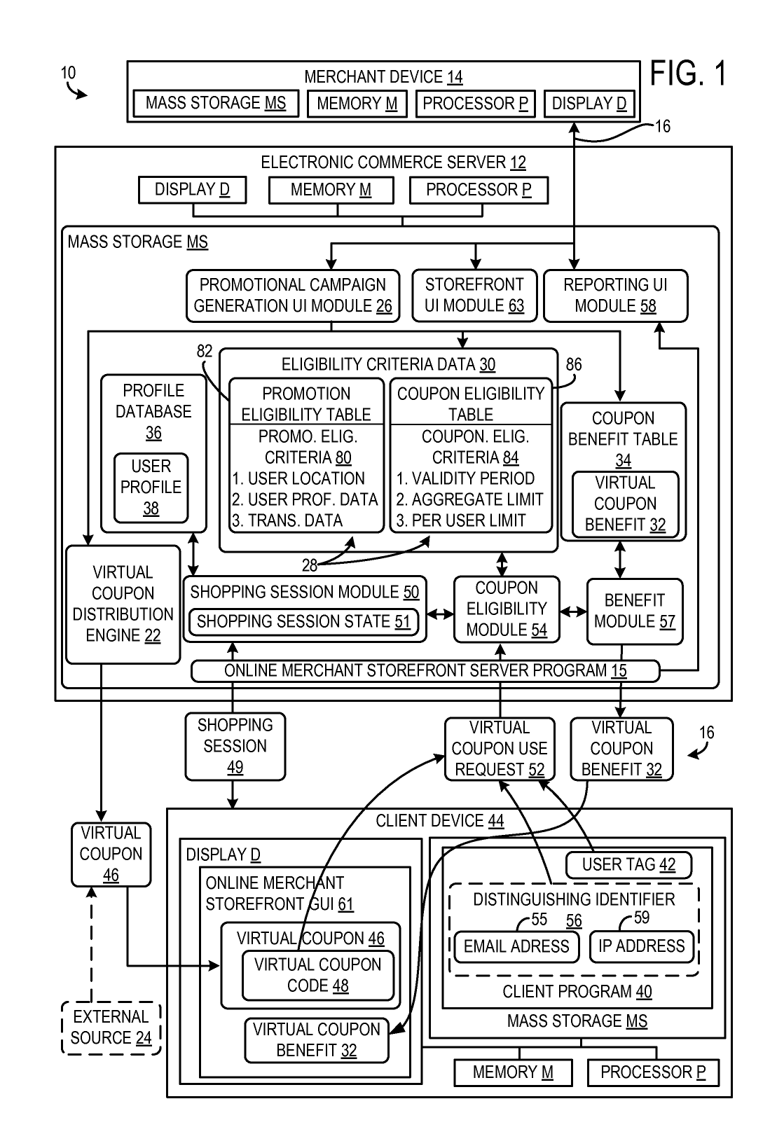

FIG. 1 shows a schematic depiction of an electronic commerce system 10. The electronic commerce system 10 may include an electronic commerce server 12, a merchant device 14, and a client device 44, each of which has an associated memory M, mass storage MS, processor P and display D. Programs stored in mass storage are configured to be implemented by each processor using portions of memory to perform the various functions described herein, and to produce corresponding output displayed on each display. Merchant device 14 and client device 44 are configured to communicate with the electronic commerce server 12 over a computer network 16, which is typically a wide area network (WAN) such as the Internet. While the electronic commerce server 12 is shown schematically as one device, it will be appreciate that it may include multiple coordinated web servers, application servers, and database servers that may be co-located in a data center, or distributed in different locations across the computer network. Further, if desired, the merchant device 14 may be connected via a local area network (LAN) to the electronic commerce server 12.

The electronic commerce server 12 is configured to execute an online merchant storefront server program 15 to serve an online store such as an online merchant storefront graphical user interface (GUI) 61, which is displayed on client device 44. A user of the merchant device 14 may configure aspects of the online merchant storefront server program 15, such as the type of goods and services available, images and textual descriptions of each product, and the price for each, using a storefront user interface (UI) module 63 configured to receive merchant input from merchant device 14. It will be appreciated that the online merchant storefront server program 15 may be a web server accessible via a web browser, or may be an application server that interacts with an application program executed on the client device 44. A reporting UI module 58 is configured to provide a UI to the merchant device 14, which displays usage and purchase statistics for the online merchant storefront server program.

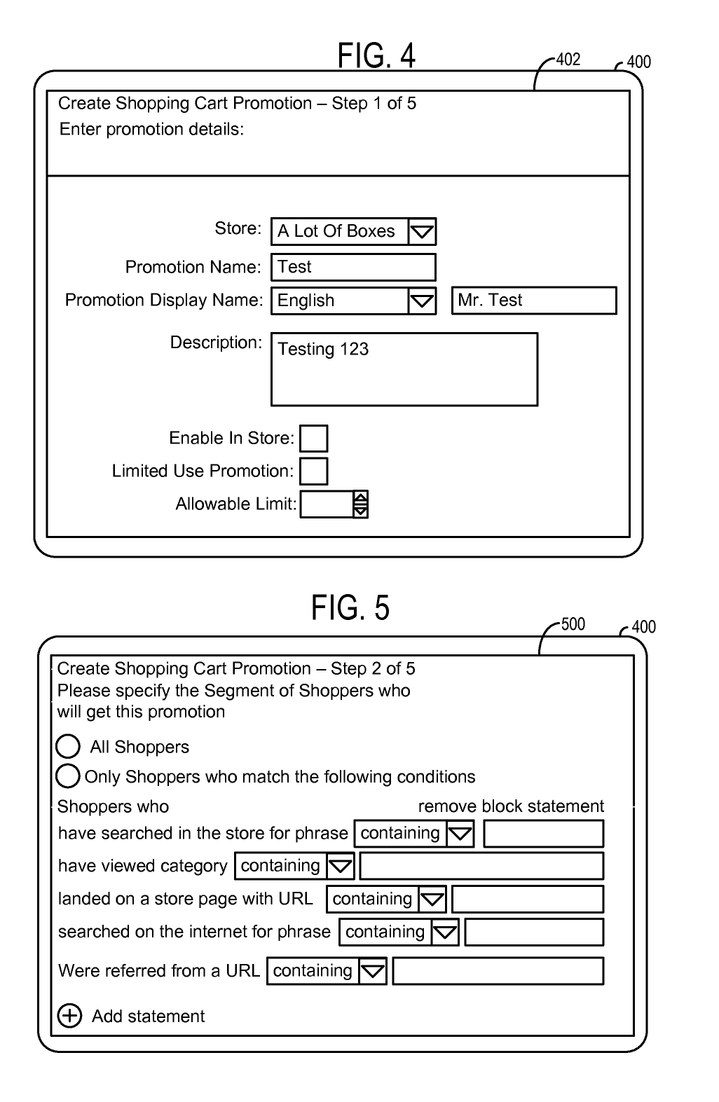

The electronic commerce system 10 may be configured to enable a user of the merchant device 14 to create and manage promotional campaigns, such as a virtual coupon campaign. A promotional campaign generation user interface (UI) module 26 is configured to display a user interface on the merchant device 14, by which a user of the merchant device may input various parameters defining a promotional campaign. The promotional campaign generation UI 26 may be configured to receive promotional campaign data from the merchant device 14. Exemplary windows showing the promotional campaign generation UI 26 are shown in FIGS. 4-14, discussed in greater detail herein.

Based on the input received via the promotional campaign generation UI module 26, a virtual coupon distribution engine 22 of the electronic commerce server 12 is configured to generate and distribute a plurality of virtual coupons. The virtual coupon distribution engine is configured to generate a virtual coupon code 48 associated with each virtual coupon 46. The virtual coupon code is typically a non-unique code, which is potentially redeemable by multiple users. The virtual coupons may be distributed via electronic methods such as being included in promotional emails or other electronic messages sent to prospective customers through the computer network 16, being displayed in advertising on websites, etc. In addition or alternatively, the virtual coupons may be distributed via a non-electronic method such as a printed publication (magazine, newspaper, etc.), direct mailing, handout, or poster, by an external source 24, such as an advertising agency.

The virtual coupon may include an associated virtual coupon benefit 32 that may be redeemed via the electronic commerce server 12, as discussed below. Specifically the promotional offer may correspond to a good and/or service sold via the online merchant storefront server program 15 hosted by the electronic commerce server 12.

The promotional campaign generation UI 26 is also configured to receive eligibility criteria data 30 including eligibility criteria 28 for virtual coupons associated with a specified promotional campaign. The eligibility criteria 28 may include promotion eligibility criteria 80 which may be stored in a promotion eligibility table 82. The eligibility criteria 28 may further include coupon eligibility criteria 84 which may be stored in coupon eligibility table 86. It will be appreciated that the coupon eligibility table 86 and the promotion eligibility table 82 may store eligibility criteria 28 for a virtual coupons of a single promotional campaign, or may store plurality of sets of eligibility criteria, each set associated with a different virtual coupon and promotional campaign. Other aspects of the promotional campaign which may be generated and/or identified via the promotional campaign generation UI include a name of the promotional campaign, a reference number associated with the promotional campaign, and the online storefronts associated with the promotional campaign, etc.

The coupon eligibility criteria 84 may include an eligibility criterion pertaining to a validity period in which a virtual coupon benefit may be offered. For example, a user of the merchant device 14 may specify the starting date and time and ending date and time of the promotional campaign. In this way, a user of the merchant device 14 may impose time constraints on the campaign.

The coupon eligibility criteria 84 may further include a coupon use limit specifying the number of times a virtual coupon may be used. The coupon use limit may include an aggregate use limit for all the virtual coupons in the promotional campaign or may be a per-user limit indicated how many times each user may redeem the virtual coupon. For example, a user of the merchant device 14 may specify an aggregate limit of X times that a virtual coupon may be used to redeem a virtual coupon benefit by all users during the entire validity period of the promotional campaign. In addition or in the alternative, a user of the merchant device may specify that each user may only use the virtual coupon in a promotional campaign to receive a virtual coupon benefit up to a total per user limit of Y number of times.

The promotion eligibility criteria 80 may also include a geographical criteria defining at least one eligible location, or geographical region, where a client device must be located in order to be eligible to receive a virtual coupon benefit. For example, one or more eligible zip/postal codes, time zones, etc., may be defined. Alternatively, locations such as “in the office” or “at home” or “in Store A” may be defined as the geographical criteria.

The promotion eligibility criteria 80 may further include the goods and/or services being purchased in a transaction between the electronic commerce server and a user of a client device being of a specific type or above a threshold price. Thus, a user of the merchant device 14 may limit the promotion to only certain users, products, or transaction amounts that it wishes to target. The eligibility criteria may also include a required user profile data parameter pertaining to user profile data stored via the electronic commerce server 12 and/or the client program 40, discussed in greater detail herein. Further in some examples, object relations between eligibility criteria transferred between devices or systems within the electronic commerce server 12 may be decoupled.

The promotional campaign generation UI 26 may further be configured to generate and/or identify at least one virtual coupon benefit 32 which may be stored in coupon benefit table 34 and associated with the virtual coupon 46. It will be appreciated that the promotion eligibility table 80, the coupon eligibility table 84, and/or the coupon benefit table 34 may be queried by the electronic commerce server 12 to retrieve data stored therein. Moreover, the virtual coupon benefit 32 and the eligibility criteria 28 both correspond to a promotional campaign created by the promotional campaign generation UI module by the merchant device. It will also be appreciated that the virtual coupon benefit table 34, the coupon eligibility table 82, and/or the promotion eligibility table 86 may store additional eligibility criteria and virtual coupon benefits corresponding to other promotional campaigns.

The virtual coupon benefits 32 may include, for example, discount data defining a monetary discount for a good and/or service. For example, the virtual coupon benefit may be a percentage discount on a good/service or a dollar amount off the cost of a good/service. Additionally or in the alternative, the virtual coupon benefits may define the good and service to which it corresponds. Another exemplary virtual coupon benefit 32 is a shipping discount. For example, the virtual coupon benefit 32 may be free shipping of a good and/or service that has been purchased. A variety of other virtual coupon benefits 32 may be utilized.

The electronic commerce server 12 may further include a profile database 36, which stores a user profile 38. Although a single user profile is shown it will be appreciated that a plurality of user profiles may be stored in the profile database 36. The user profile 38 may include one or more of the following data types: browsing history data, transaction history data, demographic data, location data, Internet Protocol (IP) address, email address, and payment data. The transaction history may include data corresponding to a previous transaction between client program 40 such as a browser and the electronic commerce server 12. Each profile may be associated with a user tag 42 of an authenticated user of client program 40. In some examples, the user tag 42 may be generated via the electronic commerce server 12 and stored in a cookie or other data store of the client program 40 during a shopping session 49, discussed in greater detail herein. For example, the user tag 42 may be appended to a uniform resource locator (URL), and passed back and forth in the request and response stream between client device 44 and electronic commerce server 12. For some types of user profile data, the electronic commerce server may read the cookie to retrieve information from the client device 44 and store it in the user profile 38 at the server. For other types of user profile data, the electronic commerce server tracks on the server-side and stores in the user profile 38. For example, coupon redemptions may be tracked by eligibility module 54 discussed below and stored in the user profile, while more general shopping history may be tracked by the shopping session module 50 and stored in the user profile 54, as discussed below.

The browsing history stored in the user profile may pertain to previous network navigation carried out by the user of the client program at the electronic commerce server, or affiliated websites of the electronic commerce server. Browsing history within the electronic commerce server 12 may be tracked by server 12, while browsing at affiliated website may be tracked by setting and reading cookies at the client device and inspecting the referral URL parameter embedded within web requests. Thus, the browsing history in the user profile may include the addresses of a plurality of affiliated websites visited by the user of the client program 40.

The transaction history data may include data pertaining to previous goods and/or services transaction between the client program 40 and the electronic commerce server 12, which may be tracked by the shopping session module 50. For example, prior goods and/or services purchased by a user, the cost of the goods and/or services, the date and/or time of the transaction may be included in the transaction history data. Additionally, the demographics may include an age and gender of a user of the client program 40, which are typically inputted by the user on an opt-in basis. The location data may include geolocation data such as latitude and longitude of the client device detected by a GPS receiver. Further, the location data may include a location such as city, state, and/or a country, or a “place” defined by a mapping service or social network, etc., at which the client device 44 executing the client program 40 is determined to be. The location data may be passively detected, as is the case with geolocation data, or based on user input, as is the case with city, state, country, and “place” defined by a mapping service or social network. Payment information may include a credit card number, a bank routing number, etc., used by the user of the client program 40 in a previous transaction.

As discussed above a plurality of virtual coupons may be distributed via the virtual coupon distribution engine 22. Specifically, a virtual coupon 46 may be distributed to the client program 40. Alternatively, the virtual coupon may be stored in another location in the network 16 and accessed via the client program 40. The virtual coupon may include a promotional offer associated with virtual coupon benefit 32. The virtual coupon may include text, audio, and/or video data conveying the promotional offer to a user. The virtual coupon 46 further includes a virtual coupon code 48. In some cases, the virtual coupon may be distributed only to a user group that satisfies the promotional eligibility criteria, as discussed above. In this manner, a user group in a specific location, a user group purchasing specific products from the electronic commerce server 12, and/or a user group possessing certain user profile characteristics may be targeted for a promotion by the merchant. Further, it will be appreciated that promotional eligibility and coupon eligibility are separately defined. Thus, in one use case scenario, a merchant may define promotional eligibility, and then distribute more than one virtual coupon to the eligible user group, each virtual coupon having different coupon eligibility criteria associated with it. For example, the merchant might distribute a first virtual coupon to the eligible user group, and following time expiration or exhaustion of that virtual coupon, the merchant might distribute a second virtual coupon to the same eligible user group.

The virtual coupon 46 may be configured to send a virtual coupon use request to the electronic commerce server 12. The use request may be triggered via user input or may be triggered programmatically. The virtual coupon code 48 may be a non-unique code usable at the electronic commerce server 12 via a plurality of users. In other words the virtual coupon code 48 may be shared among a plurality of coupons. When a non-unique code is used the computing resource used by the electronic commerce server 12 for coupon management (e.g., tracking) is reduced, thereby increasing the efficiency of the electronic commerce server 12. As a result the cost of the promotional campaign associated with the virtual coupon code may be reduced.

A user of the client program 40 may trigger initialization of a shopping session 49 with a shopping session module 50 included in the electronic commerce server 12. Specifically, the user may be authenticated for use of the client program 40. The shopping session module 50 may store and update a shopping session state 51 associated with shopping session 49. The shopping session state may include various types of data such as goods and/or services viewed, goods and/or services in a shopping cart, goods and/or services purchased, purchase data, etc.

The client program 44 may be a browser or application program that is configured to store user profile data specific to the user's navigation and/or transaction history with network sites (e.g., websites) affiliated with the online merchant storefront server program 15. For example, cookies may be used that are able to be interpreted not only by electronic commerce server 12, but also by other affiliated electronic commerce servers, ad servers, etc. In this way, cross-site and cross brand promotions may be implemented.

A user may choose to redeem the virtual coupon during the shopping session 49. Therefore, a virtual coupon use request 52 may be sent to an eligibility module 54 included in the electronic commerce server 12 from the client device 44 (e.g., client program 40). The virtual coupon request may be sent to the eligibility module 54 in response to user input or programmatically. However in other embodiments the virtual coupon use request 52 may initiate a shopping session with the shopping session module 50.

Subsequent to transfer of the virtual coupon use request 52 the eligibility module 54 may detect a distinguishing identifier 56 associated with the virtual coupon use request, the client program 40, and/or user of the client program 40. The distinguishing identifier 56 may be an email address 55 and/or an IP address 59, for example.

The eligibility module 54 may further be configured to determine the eligibility criteria 28 and at least one virtual coupon benefit 32 corresponding to the virtual coupon code 48. The eligibility module 54 may query the coupon eligibility table 84 and/or the promotion eligibility table 82 to determine eligibility criteria corresponding to the virtual coupon use request 52. In one example, the eligibility module 54 may separately query the coupon eligibility table 84 and the promotion eligibility table 82 to determine the coupon eligibility criteria 84 and the promotion eligibility criteria 80. In this way, data in the virtual coupon may be used to determine eligibility criteria associated with the virtual coupon 46.

The eligibility module 54 may further be configured to determine if the user of the client program 40 is eligible to receive the virtual coupon benefit 32 based on the distinguishing identifier and the eligibility criteria 28. For example, the eligibility module may be configured to determine if each eligibility criterion associated with the virtual coupon 46 are fulfilled by the user of the client program 40.

Furthermore, the eligibility module 54 may be configured to determine if the client program 40 is eligible to receive the virtual coupon benefit 32 based on the user profile 38. Specifically, the user tag 42 may be used to identify the user profile 38 associated with the user of client program 40. Subsequently, the eligibility module may be configured to compare user profile parameters included in the user profile 38 to the eligibility criteria 28 to determine eligibility. It will be appreciated that when the user profile 38 is used to determine eligibility the interaction between the client program 40 and the electronic commerce server 12 may be reduced. As a result, the efficiency of the electronic commerce system 10 is increased, thereby reducing system costs.

The electronic commerce server 12 includes benefit module 57 configured to provide the virtual coupon benefit 32 to the user of the client program 40 if the user of the client program 40 is eligible. In some examples, the benefit module 47 may query the coupon benefit table 34 to retrieve the virtual coupon benefit. In some examples the virtual coupon benefit may be provided to the user of the client program after the shopping session has been finalized. Although a single virtual coupon benefit is depicted it will be appreciated that a plurality of virtual coupon benefits may be provided to the user of the client program 40 if the user of the client program is eligible. However, if the benefit module 57 determines that eligibility criteria have not been fulfilled then the virtual coupon benefit is not provided to the user of the client program 40.

The electronic commerce server 12 may further include a reporting UI module 58 configured to present promotional campaign data to the merchant device 14. The reporting UI module 58 may be configured to retrieve data generated by the online merchant storefront server program 15, which indicates the usage of virtual coupons distributed by the merchant device and redeemed via the online merchant storefront server program. In this way, a user of the merchant device 14 can track the progress of a promotional campaign. For example, coupon usage data and coupon user data may be provided in the reporting UI module 58.

Each of the processors P may include one or more physical devices configured to execute one or more instructions. For example, each of the processors may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The processors may be configured to execute software instructions. Additionally or alternatively, the processors may include one or more hardware or firmware logic machines configured to execute hardware or firmware instructions. It will be appreciated that each of the processors P may be differently configured, according to the needs of each device.

The memory M included in the client device 44, the electronic commerce server 12, and the merchant device 14 may each include one or more physical devices configured to hold data and/or instructions executable by the processor to implement the herein described methods and processes. When such methods and processes are implemented, the state of memory may be transformed (e.g., to hold different data). The memory M may include removable media and/or built-in devices. The memory M may include optical memory devices, semiconductor memory devices, and/or magnetic memory devices, among others. The memory may include devices with one or more of the following characteristics: volatile, nonvolatile, dynamic, static, read/write, read-only, random access, sequential access, location addressable, file addressable, and content addressable. It will be appreciated that each memory M may be differently configured, according to the needs of each device.

Additionally, the display D included in the client device 44 may be used to present a visual representation of data held by memory M. Likewise display D included in the merchant device 14 may be used to present visual representation of data held by memory. The processor and memory included in the client device 44 may be integrated into one or more common devices, such as an application specific integrated circuit or a system on a chip. Additionally, the processor P and memory M included in the electronic commerce server 12 may be integrated into one or more common devices. Likewise, the processor P and memory M included in the merchant device 14 may be integrated into one or more common devices.

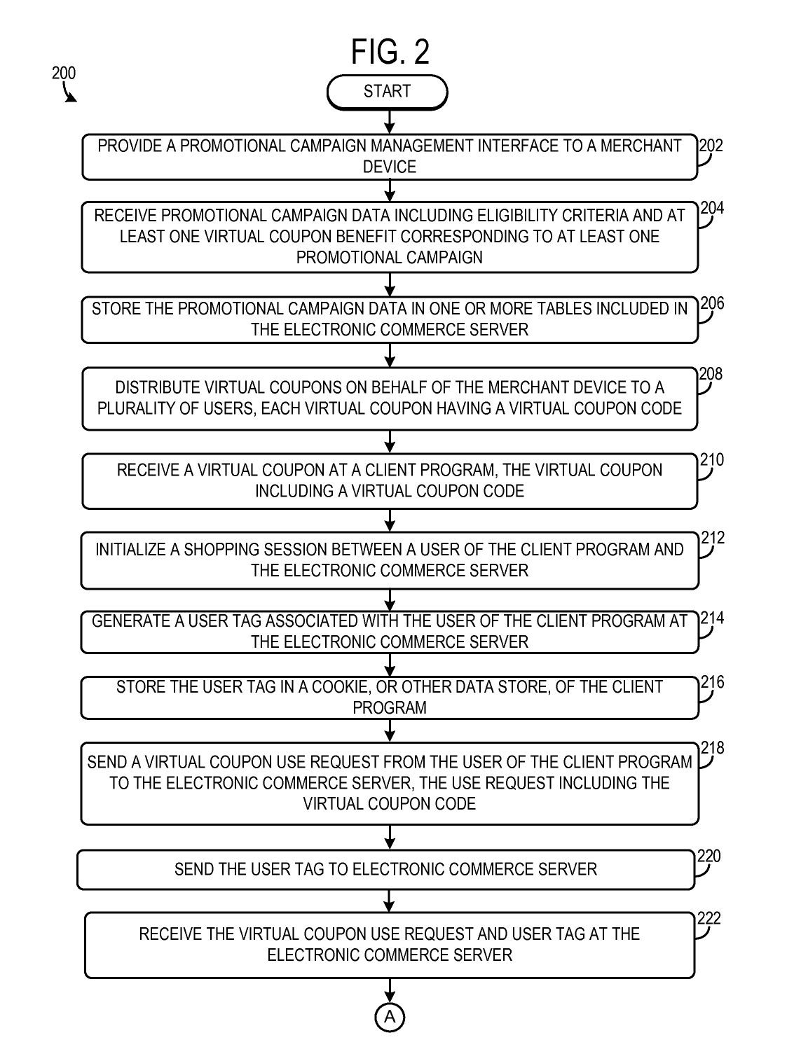

FIG. 2 shows a method 200 for managing a promotional campaign in an electronic commerce system. Method 200 may be implemented via the system, components, and/or other constituents of the electronic commerce system 10, described above with regard to FIG. 1, or may be implemented via other suitable systems, components, etc.

At 202, the method includes providing a promotional campaign management interface to a merchant device. The promotional campaign management interface may be configured to receive data input from a merchant device associated with a promotional campaign such as eligibility criteria and virtual coupon benefits corresponding at least one promotional campaign. In this way, a user of the merchant device may set up a promotional campaign and tailor various aspects of the promotional campaign to their liking.

Next, at 204 the method includes receiving promotional campaign data including eligibility criteria and at least one virtual coupon benefit corresponding to at least one promotional campaign. As previously discussed the eligibility criteria define the rules used to determine if a user of a client program is entitled to receive a virtual coupon benefit.

At 206 the method includes storing the promotional campaign data in one or more tables included in the electronic commerce server. Specifically in some embodiments the eligibility criteria may be stored in a coupon eligibility table and the at least one virtual coupon benefit may be stored in coupon benefit table.

Next, at 208 the method includes distributing virtual coupons on behalf of the merchant device to a plurality of users, each virtual coupon having a virtual coupon code. In some embodiments, each virtual coupon code may be a non-unique code usable at the electronic commerce server by multiple users. When a non-unique virtual coupon code is used the processor resource needed by the electronic commerce server for management of the virtual coupons and the promotional campaign as a whole is reduced. As a result the efficiency of the electronic commerce server is increased.

At 210 the method includes receiving a virtual coupon at the client program, the virtual coupon including the virtual coupon code. At 212 the method includes initializing a shopping session between a user of the client program and the electronic commerce server. In the shopping session the user may request to purchase goods and/or services from a retail site (e.g., online store) served by the online merchant storefront server program. However in other embodiments step 212 may not be included in method 200. At 214 the method includes generating a user tag associated with the user of the client program at the electronic commerce server. It will be appreciated that the user tag may be generated during a user session, and used to identify the user to the electronic commerce system. At 216 the method includes storing the tag in a cookie, or other data store, of the client program. In other embodiments steps 214 and 216 may not be included in method 200.

At 218 the method includes sending a virtual coupon use request from the user of the client program to the electronic commerce server, the use request including the virtual coupon code.

At 220 the method includes retrieving the user tag from the cookie, or other data store, associated with the client program and sending the user tag to the electronic commerce server. In some embodiments step 218 and 220 may be implemented contemporaneously. Further in some embodiments the electronic commerce server may cache the user tag and distinguishing identifier including the user tag.

At 222 the method includes receiving the virtual coupon use request and the user tag at the electronic commerce server. Specifically in some embodiments an eligibility module included in the electronic commerce server may receive the virtual coupon use request. It shall be noted that when step 212 is not included in method 200 a shopping session may be initialized in response to receiving the virtual coupon use request. Furthermore it will be appreciated that the virtual coupon use request may be received in the course of a shopping session at an online store of a merchant device hosted by the electronic commerce server, in which the user is requesting to purchase goods and/or services from the online store.

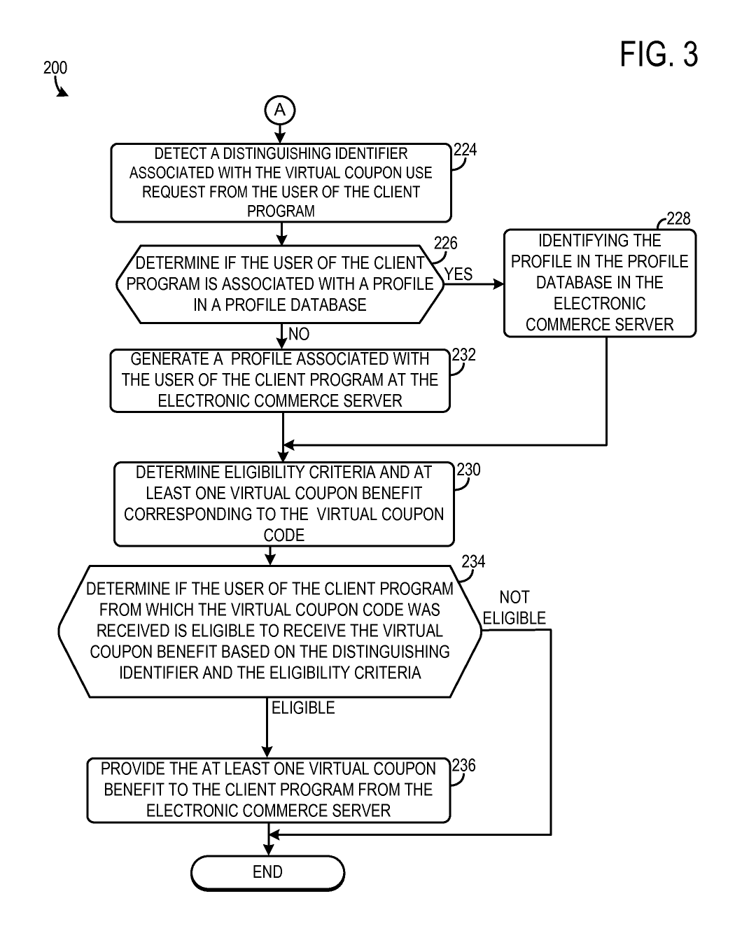

Now referring to FIG. 3, at 224 the method includes detecting a distinguishing identifier associated with the virtual coupon use request from the user of the client program. As previously discussed the distinguishing identifier may be an IP address and/or an email address. The IP address of the client device may be detected from the requests received from the client program at the electronic commerce server. The email address of the user may determined by receiving user input of the email address contemporaneously with the transaction request and/or by looking the email address of the user up in user profile data for the user stored in the cookie or other data store associated with the client program and user tag on the client device and/or in a user profile associated with the user tag at the electronic commerce server.

At 226 the method includes determining if the user of the client program is associated with a profile in a profile database in the electronic commerce server. In some embodiments the user tag in the cookie received at step 220 may be used to determine if the user of the client program is associated with a profile in the profile database. In this way, sending a request for identification information to the user of the client program from the electronic commerce server may not be necessitated, thereby increasing the efficiency of the method.

If it is determined that the user of the client program is associated with a profile (YES at 226) the method includes at 228 identifying the profile in the profile database at the electronic commerce server. The profile may be associated with the distinguishing identifier and/or the user tag. After 228 the method proceeds to 230. At 230 the method includes determining eligibility criteria and at least one virtual coupon benefit corresponding to the virtual coupon code.

However, if it is determined that the user of the client program is not associated with a profile (NO at 226) the method includes at 232 generating a profile associated with the user of the client program at the electronic commerce server. After 232 the method proceeds to 230.

At 234 the method includes determining if the user of the client program from which the virtual coupon code was received is eligible to receive the virtual coupon benefit based on the distinguishing identifier and the eligibility criteria. Determining if the user of the client program from which the virtual coupon code was received is eligible to receive the virtual coupon benefit may be accomplished as described above in relation to FIG. 1. For example, user profile parameters, transaction data, etc., may be compared to the eligibility criteria for the virtual coupon to see if each of the eligibility criteria is satisfied. Thus, eligibility criteria such as validity period, aggregate use limits, per-user limits, user location requirements, user profile data requirements, and transaction data requirements (e.g., product type, transaction amount threshold) may be enforced.

If the user is not eligible to receive the virtual coupon benefit (NO at 234) the method ends. Alternatively, the method may return to 234 if the user is not eligible to receive the virtual coupon benefit. In this way a user may to take action to fulfill eligibility criteria that are dependent of user action. However if the user is eligible to receive the virtual coupon benefit (YES at 234) the method includes at 236 providing the at least one virtual coupon benefit to the client program from the electronic commerce server.

It will be appreciated that method 200 has the potential benefit of enabling quick and efficient management of a promotional campaign without excessively increasing campaign costs, since non-unique virtual coupon codes may be utilized, while still enabling the merchant device to enforce per-user and aggregate coupon limits by utilizing distinguishing identifiers such as email address and IP address.

FIGS. 4-14 illustrate various windows that may be generated by the promotional campaign generation UI module 26, shown in FIG. 1. The windows shown in FIGS. 4-14 may be presented on the display 400. Display 400 may be similar to display D of merchant device 14 shown in FIG. 1. It will be appreciated that the windows and campaign data (e.g., eligibility criteria and virtual coupon benefits) are exemplary in nature and that numerous suitable windows may be generated by the promotional campaign generation UI module.

FIG. 4 shows a window 402 in which a user of the merchant device 14, shown in FIG. 1, may input and/or select promotional campaign data such as the store providing the promotional benefit, the name of the promotion, the display name of the promotion, the language of the display name of the promotion, a description of the promotion.

FIGS. 5-8 show various windows generated by the promotional campaign generation UI module 26, shown in FIG. 1. Specifically FIG. 5 shows a window 500 which provides a merchant various fields to enter eligibility criteria associated with a promotional campaign. The eligibility criteria may be related to a user's browsing history such as phrases searched in an online store, categories viewed in an online store, pages visited in the online store with a specified URL, phrases searched on the Internet, and users that were referred from a specified URL. Additionally, the merchant may add additional statements to further expand the eligibility criteria.

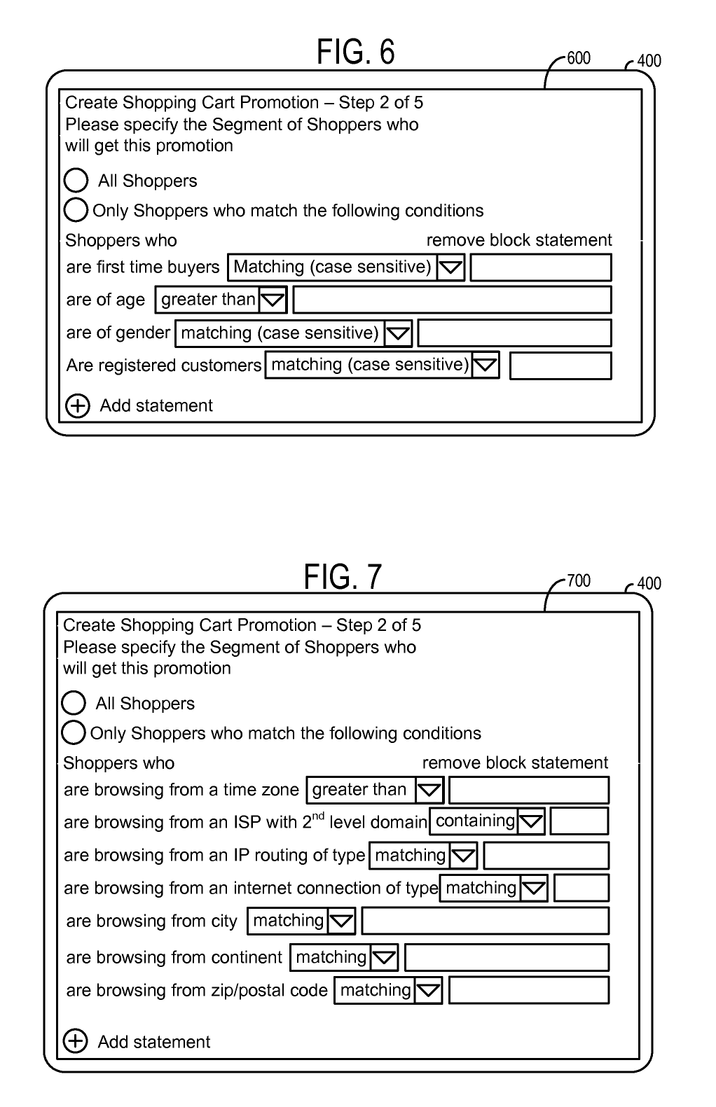

FIG. 6 shows another window 600 which provides the merchant device 14, shown in FIG. 1, with additional fields to enter eligibility criteria that may include a criterion related to user demographics such as the age of the user and the gender of the user. The eligibility criteria may further include a transaction history criterion, such as if user is a registered customer or a first time buyer.

FIG. 7 shows another window 700 which provides the merchant 14, shown in FIG. 1, with additional fields to enter eligibility criteria. As shown the eligibility criteria may include geolocation criteria such as the time zone in which the client device is operating, the city in which the client device operating, the continent in which the client device is operating, and the zip/postal code in which the client device is operating. Additional eligibility criteria include network connection data such as what domain level the Internet service provider (ISP) associated with the client device, the type of routing used by the ISP, the type of network (e.g., Internet) connection utilized by the client device, etc. It will be appreciated that the ISP may provide the client device with access to the network 16, shown in FIG. 1.

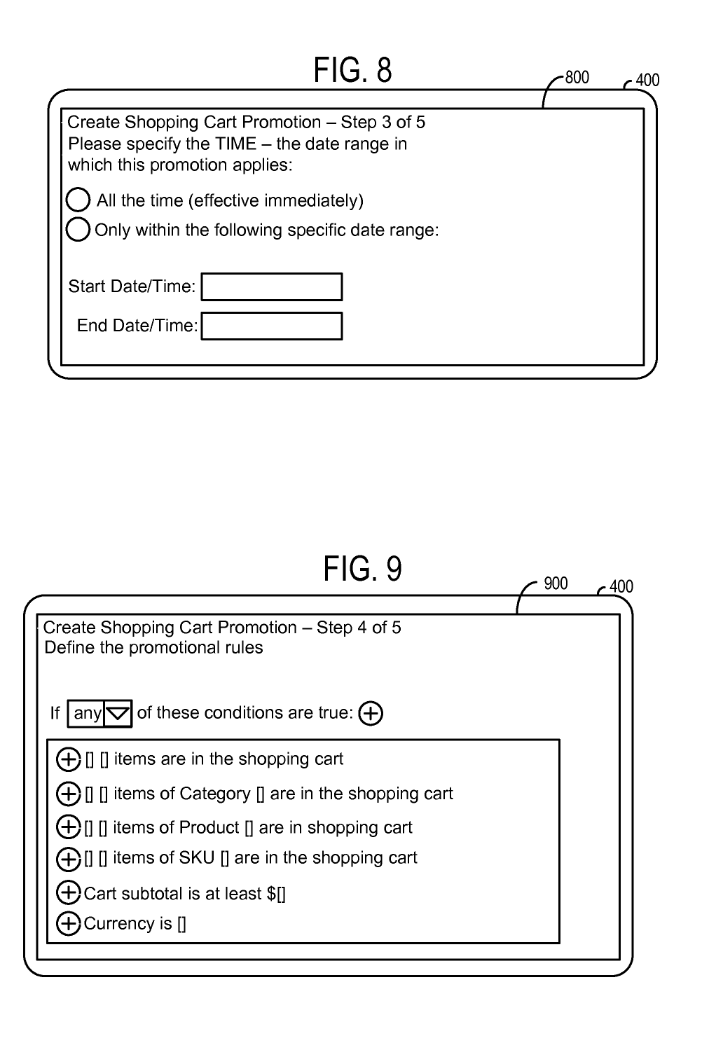

FIG. 8 shows another window 800 which provides the merchant 14, shown in FIG. 1, with additional fields to enter eligibility criteria. As shown the eligibility criteria may include a time range in which the virtual coupon benefit may be offered, the time range including a start date/time and an end date/time.

FIG. 9 shows another window 900 which provides the merchant 14 with additional fields to enter eligibility criteria. As shown the eligibility criteria may include transaction data corresponding to the current shopping session of a user of the client device. For example, the eligibility criteria may include the number and/or type of items required to be in a shopping cart, the number of items in a specified category, product, and/or stock-keeping unit (SKU) are in the shopping cart. Additionally, the eligibility criteria may require the shopping cart to have a subtotal of a set numerical value and/or use a specified type of currency.

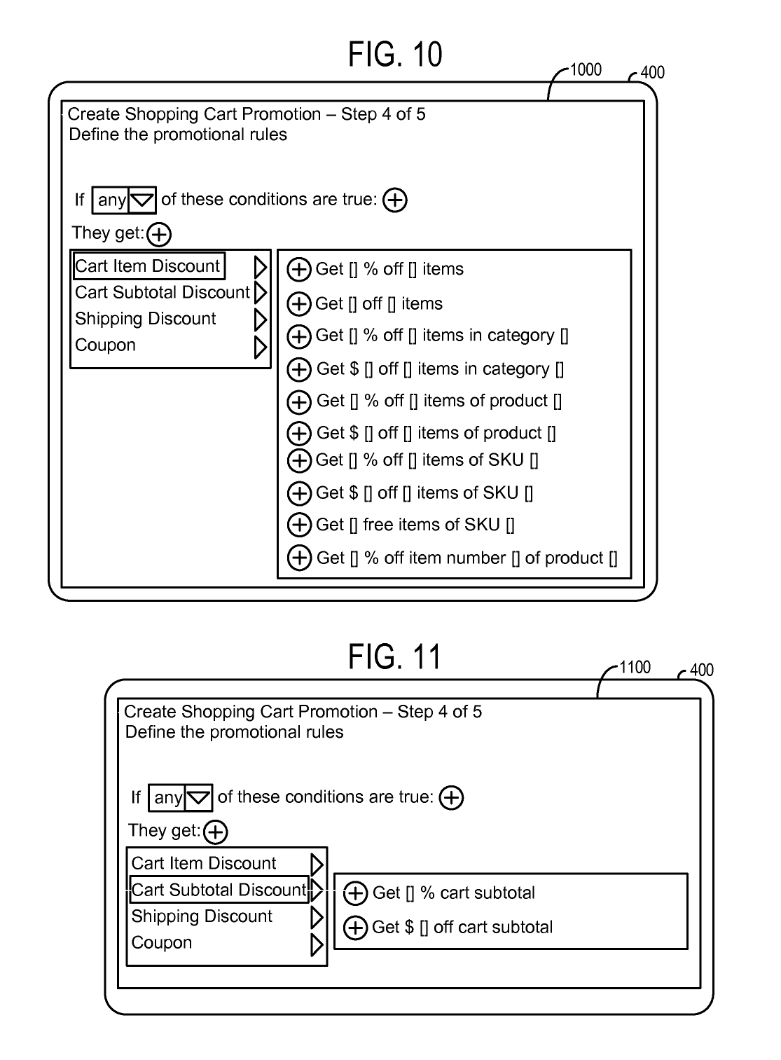

FIGS. 10-13 show various example windows which may be included in the promotional campaign generation UI 26, shown in FIG. 1, to enable a merchant to input virtual coupon benefits into the electronic commerce server 12, shown in FIG. 1.

Specifically FIG. 10 shows an example window 1000 enabling the merchant 14, shown in FIG. 1, to input a percentage and/or dollar discount that may be applied to specified items, item categories, items of a certain type of product, and items having a specified SKU. This is an example of a virtual use coupon that is tied to a particular product type, wherein the virtual coupon benefit is a percentage or dollar discount.

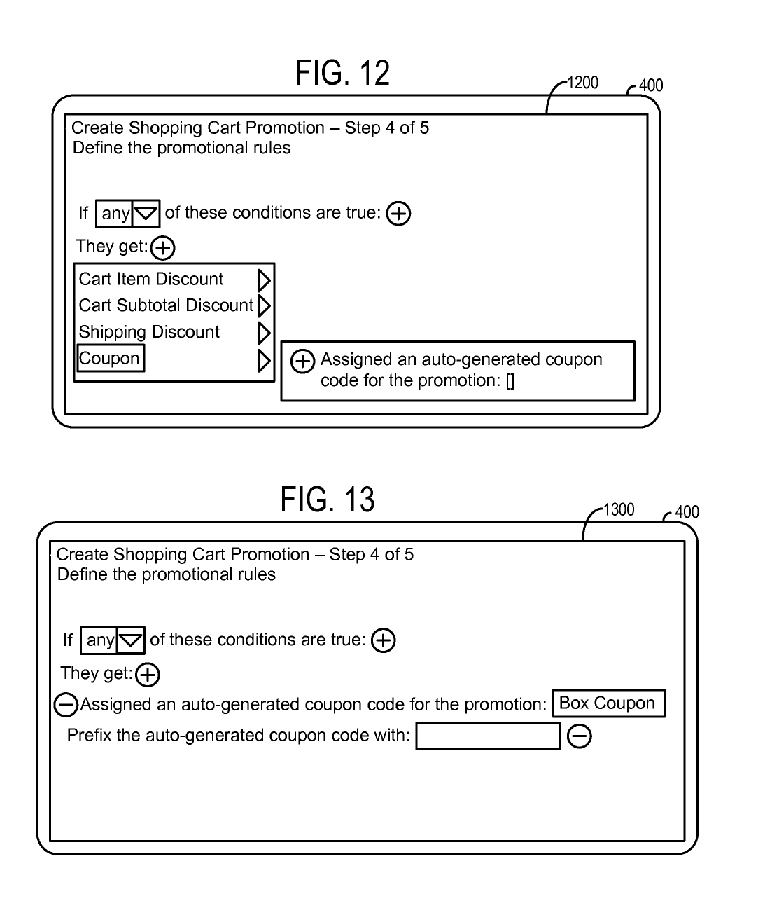

FIG. 11 shows an example window 1100 enabling the merchant 14, shown in FIG. 1, to input benefits related to a percentage or dollar discount off a shopping cart subtotal. FIG. 12 shows another example window 1200 for input a benefit for assigning an auto-generated coupon code for a specified promotion. FIG. 13 shows another example window 1300 in which a prefix may be assigned to an auto-generated coupon.

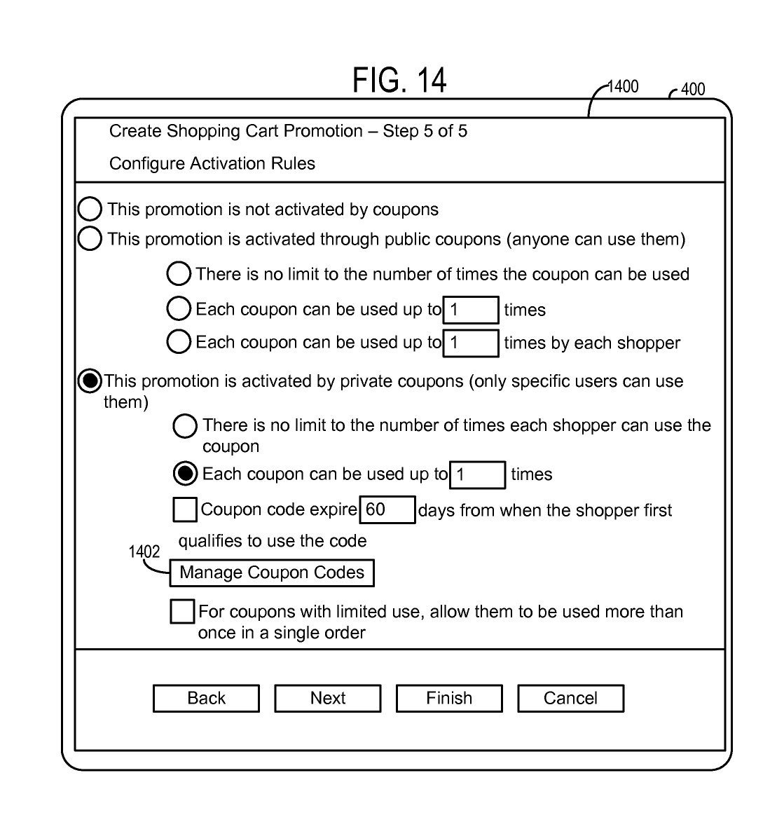

FIG. 14 shows an example window 1400 enabling a user of the merchant device 14, shown in FIG. 1, to input additional eligibility criteria data. The eligibility criteria data may pertain to the way in which coupon benefits are distributed. For example, a user of the merchant device may specify that a virtual coupon may not be required to receive a virtual coupon benefits or that virtual coupon benefit eligibility may provided publically to any user having a virtual coupon. Additionally, the user may specify that virtual coupon benefits may only be provided to selected users. As shown an aggregate use limit for all the virtual coupons in the promotional campaign may be specified by a user of the merchant device. Additionally, a per-user limit indicating how many times each user may redeem a virtual coupon may be specified by a user of the merchant device. Furthermore, a validity period from when a shopper first qualified for a promotional coupon may be specified. Additional eligibility criteria data may include selectively enabling a virtual coupon to be used more than once in a single order. A button 1402 may also be provided to manage coupon codes.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for managing a promotional campaign in an electronic commerce system, the method comprising, at an electronic commerce server:
receiving a virtual coupon use request including a multiple-user virtual coupon code from a user of a client program executed on a client device;
detecting a distinguishing identifier associated with the virtual coupon use request from the user of the client program;
determining eligibility criteria and at least one virtual coupon benefit corresponding to the virtual coupon code;
determining if the user of the client program from which the virtual coupon code was received is eligible to receive the virtual coupon benefit based on the distinguishing identifier and the eligibility criteria; and
if the user of the client program is eligible, providing the virtual coupon benefit to the user of the client program.

2. The method of claim 1, further comprising, prior to receiving the virtual coupon use request, distributing a plurality of virtual coupons on behalf of a merchant to a plurality of users, each virtual coupon having a virtual coupon code, each virtual coupon code being a non-unique code usable at the electronic commerce server by multiple users.

3. The method of claim 1, wherein the virtual coupon use request is received in the course of a shopping session at an online store of a merchant device hosted by the electronic commerce server, in which the user is requesting to purchase goods and/or services from the online store.

4. The method of claim 3, wherein the eligibility criteria includes goods and/or services being purchased be of specific type or above a threshold price.

5. The method of claim 1, wherein the eligibility criteria includes a geographical criteria defining at least one eligible geographical region where the client device must be located in order to be eligible to receive the virtual coupon benefit.

6. The method of claim 1, wherein the eligibility criteria includes a coupon usage limit defining a limited number of redemptions for a virtual coupon.

7. The method of claim 6, wherein the coupon usage limit is at least one of an aggregate limit and a per-user limit.

8. The method of claim 1, wherein the electronic commerce server is configured to store user profile data specific to the user's browsing history, transaction history with the client program and an online merchant storefront program executed via the electronic commerce server, and wherein the eligibility criteria includes a required user profile data parameter.

9. The method of claim 1, wherein at least a portion of the eligibility criteria and/or the virtual coupon benefit is stored in a table and determining the eligibility criteria and the virtual coupon benefit includes querying the table.

10. The method of claim 1, wherein the distinguishing identifier is one of an Internet Protocol (IP) address of the client device, wherein the IP address of the client device is detected by the electronic commerce server.

11. The method of claim 1, wherein the distinguishing identifier is an email address of the user, wherein the email address of the user is determined by receiving user input of the email address contemporaneously with the virtual coupon use request and/or by looking the email address of the user up in user profile data corresponding to the user stored on the client device and/or at the electronic commerce server.

12. The method of claim 1, further comprising, at the electronic commerce server, prior to determining if the user of the client program from which the virtual coupon code was received is eligible to receive the virtual coupon benefit, generating a user tag associated with the user of the client program, the user tag being stored in a cookie or other data store in the client program, the user tag being sent to the electronic commerce server contemporaneously with the virtual coupon use request to identify the user, and the user tag being associated with a user profile stored in a database at the electronic commerce server.

13. The method of claim 12, wherein the user tag is used to determine if the client program is eligible to receive the virtual coupon benefit, by identifying the user profile and comparing user profile parameters to the eligibility criteria.

14. A method for managing a promotional campaign in an electronic commerce system, the method comprising, at an electronic commerce server:
receiving a virtual coupon use request including a virtual coupon code from a user of a client program executed on a client device, the virtual coupon use request being received in the course of a shopping session at an online store of a merchant device hosted by the electronic commerce server, in which the user is requesting to purchase goods and/or services from the online store;
detecting a distinguishing identifier associated with the virtual coupon use request from the user of the client program;
determining eligibility criteria and at least one virtual coupon benefit corresponding to the virtual coupon code;
determining if the user of the client program from which the virtual coupon code was received is eligible to receive the virtual coupon benefit based on the distinguishing identifier and the eligibility criteria; and
if the user of the client program is eligible, providing the virtual coupon benefit to the user of the client program.

15. The method of claim 14, wherein the virtual coupon code is a non-unique code usable at the electronic commerce server by multiple users.

16. The method of claim 14, wherein the distinguishing identifier is one of an Internet Protocol (IP) address of the client device and an email address of the user, wherein the IP address of the client device is detected by the electronic commerce server and the email address of the user is determined by receiving user input of the email address contemporaneously with the transaction request and/or by looking the email address of the user up in user profile data for the user stored on the client device and/or at the electronic commerce server.

17. The method of claim 14, wherein the eligibility criteria includes a coupon usage limit defining a limited number of redemptions for a virtual coupon.

18. The method of claim 17, wherein the coupon usage limit is at least one of an aggregate limit and a per-user limit.

19. An electronic commerce server for managing a promotional campaign, the electronic commerce server comprising:
a shopping session module configured to initialize a shopping session with a user authenticated for used with a client program executed in a client device;
an eligibility module configured to:
receive a virtual coupon use request including a multiple-user virtual coupon code from the user of the client program, the virtual coupon use request is received in the course of a shopping session at an online store of a merchant device hosted by the electronic commerce server, in which the user is requesting to purchase goods and/or services from the online store;
detect a distinguishing identifier associated with the virtual coupon use request from the user of the client program;
determine eligibility criteria and at least one virtual coupon benefit corresponding to the virtual coupon code; and
determine if the user of the client program from which the virtual coupon code was received is eligible to receive the virtual coupon benefit based on the distinguishing identifier and the eligibility criteria;
a benefit module configured to provide the virtual coupon benefit to the user of the client program if the user of the client program is eligible.

20. The electronic commerce server of claim 18, wherein the electronic commerce server further comprises a virtual coupon distribution module configured to distribute a plurality of virtual coupons on behalf of a merchant to a plurality of users, each virtual coupon having a virtual coupon code, each virtual coupon code being a non-unique code usable at the electronic commerce server by multiple users.
